(19) United States
(12) Patent Application Publication
(10) Pub. No.: US 2002/0121711 A1
(43) Pub. Date: Sep. 5, 2002

(54) Parallel functioning distillation columns within single column structure

(76) Inventor: Jeffrey L. DeGarmo, Valley Center, KS (US)

Correspondence Address: Michael B. Hurd, SHOOK, HARDY & BACON L.L.P., 1200 Main Street, Kansas City, MO, 64105-2118, US

(21) Appl. No.: 10/083,068

(22) Filed: Feb. 26, 2002

Related U.S. Application Data
(60) Provisional application No. 60/271,584, filed on Feb. 26, 2001.

(51) Int. Cl. B01F 3/04; B23P 11/00

(52) U.S. Cl. 261/94; 29/428; 261/112.2

(57) ABSTRACT

A plurality of smaller mass transfer or exchange columns are provided within a larger column and are filled with packing to facilitate contact between fluids flowing within the smaller columns. The smaller columns are positioned in parallel and contacting relationship and preferably fill substantially the entire cross section of the larger column. At least some of the smaller columns share a common external wall. Structured packing fills the smaller columns to facilitate interaction between fluids flowing countercurrently within the smaller columns.

### CROSS REFERENCE TO RELATED APPLICATION

This application claims the benefit of provisional patent application Serial No. 60/271,584 filed Feb. 26, 2001.

### BACKGROUND OF THE INVENTION

The present invention relates generally to mass transfer and exchange columns and, more particularly, to apparatus used within those columns and methods of constructing and using same.

In mass transfer and exchange columns, packing beds made of various types of random and structured packings are utilized to facilitate interaction between countercurrently flowing vapor and liquid streams. These packings operate by providing large surface areas across which the liquid and vapor flow to increase the area of contact between the vapor and liquid. Random packings such as rings and saddles are typically dumped onto a support provided within the column, while structured packings such as corrugated plates are frequently preassembled in bricks which are then placed on grid supports within the column.

It is generally recognized that packing when used in small columns and pilot columns exhibits a greater separation efficiency than when those same types of packing are used in larger or commercial sized columns. Liquid and vapor channeling and poor lateral mixing have been reported to contribute to the reduced packing efficiency observed in larger columns.

In an effort to duplicate the greater packing efficiency of small columns, a column designed for heavy water enrichment used a large number of parallel tubes filled with rings of wire gauze packing. The tubes extended vertically within a larger column and the upper ends of the tubes were welded to a tube sheet which prevented vapor and liquid from flowing in the open areas surrounding the tubes. While higher separation efficiencies could be obtained in the smaller tubes than in the larger column, the use of a tube sheet to seal around the individual tubes was undesirable for at least two reasons. First, in order for the tube sheet to retain its structural integrity, the tubes had to be spaced sufficiently apart so that the tube sheet could be formed as a single continuous piece of metal. This spacing between adjacent tubes, however, reduced the cross-sectional area that was available for fluid flow within the column. In addition to reducing the fluid flow capacity, the use of the tube sheet to secure the tubes added significantly to the time and expense required to fabricate the column because of the need to weld each individual tube to the tube sheet.

In another approach which has been taken in an attempt to achieve small column efficiencies within a larger column, bricks of structured packing were oriented in a checkerboard pattern within the column. The plates in each brick were oriented so that they extended parallel to the plates in diagonally adjacent bricks and perpendicular to the plates in the sideways adjacent bricks. No walls separated the adjacent bricks and the desired small column efficiencies were not achieved.

A need thus exists for a column that can more closely achieve the separation efficiency of packing used in small columns without the reduction in fluid flow capacity and installation delays and expense resulting from current approaches.

### SUMMARY OF THE INVENTION

The present invention is directed to configuring a typical commercial distillation column structured or random packing layout into multiple parallel functioning distillation columns within a single or main column structure. As a result of using these multiple parallel columns, better separation efficiencies can be obtained than would normally result from conventional commercial column packing layouts. The efficient operating range is also extended up to the flood point or maximum pressure drop that can be tolerated within the columns.

In one aspect, the invention is directed to a mass transfer column comprising an external shell defining an open internal region and a plurality of vertically extending smaller columns supported within said open internal region. The smaller columns have external walls which define internal fluid passages and vapor-liquid contact packing within the internal fluid passages of at least some of the smaller columns. The external walls of at least some of the smaller columns are in contact with the external walls of adjacent smaller columns within said open internal region.

In another aspect, the invention is directed to a method of constructing a plurality of longitudinally extending smaller mass transfer columns within a larger column. The method comprises the steps of assembling together a plurality of wall panels within the larger diameter column to form external walls of a plurality of parallel extending smaller columns having internal fluid passages. At least some of the wall panels form a common portion of the external walls of adjacent smaller columns. The method includes installing packing within the internal fluid passages of the smaller columns during or after assembly of the wall panels. The packing may also be preassembled with the wall panels to facilitate formation of the smaller columns within the larger column.

### BRIEF DESCRIPTION OF THE DRAWINGS

In the accompanying drawings which form part of the specification and are to be read in conjunction therewith and in which like reference numerals are used to indicate like parts in the various views:

FIG. 1 is a fragmentary side elevation view of a larger column with portions of the column shell broken away to show a plurality of smaller columns within the larger column;

FIG. 2 is an enlarged fragmentary side elevation view of one of the smaller columns shown in FIG. 1;

FIG. 3 is a plan view of the larger column taken in horizontal section to show the circular cross section of the smaller columns;

FIG. 4 is a plan view of the larger column taken in horizontal section to show the hexagonal cross section of the smaller columns;

FIG. 5 is a fragmentary side elevation view taken in vertical section and showing the lower end of an upper wall segment inserted within the upper end of a lower wall segment;

FIG. 6 is an enlarged fragmentary plan view of the larger column showing the construction of the external walls of the smaller columns;

FIG. 7 is a bottom perspective view of a packing brick;

FIG. 8 is a somewhat schematic plan view of a wall panel and packing subassembly; and

FIG. 9 is a side elevation view of the wall panel and packing subassembly shown in FIG. 8.

### DESCRIPTION OF THE PREFERRED EMBODIMENTS

Referring now to the drawings in greater detail and initially to FIG. 1, a mass transfer column or exchange column is represented broadly by the numeral 10 and includes an external shell 12 which defines an open internal region 14 in which various column internals are located. The shell 12 has a vertically extending longitudinal axis and is generally cylindrical in configuration, but other configurations such as polygon can be utilized if desired.

Column 10 is of the type utilized for processing liquid and vapor streams, including to obtain fractionation products. One or more liquid streams are directed to the column 10 through flow lines 16 for downward flow therein and one or more vapor streams are directed to the column 10 through flow lines 18 or are generated within the column 10 for countercurrent or ascending flow. After processing within the column 10, the vapor and liquid streams are removed through overhead and bottoms flow lines 20 and 22, respectively. Because the general structure of these types of columns is well known, only a portion of the column 10 relevant to the present invention is illustrated.

A plurality of smaller columns 24 are located within the larger column 10 and are placed in side by side and contacting relationship so that they preferably fill substantially the entire cross section of the larger column 10. Each of the smaller columns 24 is generally of similar construction, with the longitudinal axes of the smaller columns 24 being arranged parallel to each other and to the vertical longitudinal axis of the larger column 10.

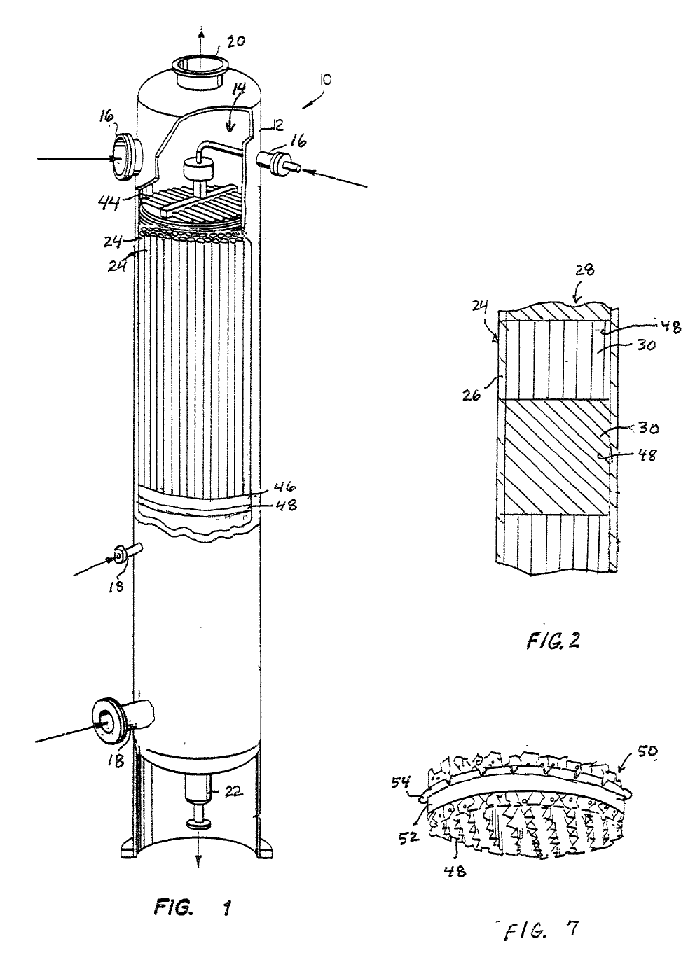

As can be seen in FIG. 2, each smaller column 24 comprises a perimeter or external wall 26 defining an internal fluid passage 28 in which packing 30 is placed and through which vapor and liquid streams flow in countercurrent relationship. The external walls 26 restrict or prevent lateral flow of fluid from one smaller column 24 to another smaller column 24 and are preferably liquid and vapor impermeable. The material used to form the external wall 26 can be various metals, polymers and ceramics which are compatible with the conditions within the column 10.

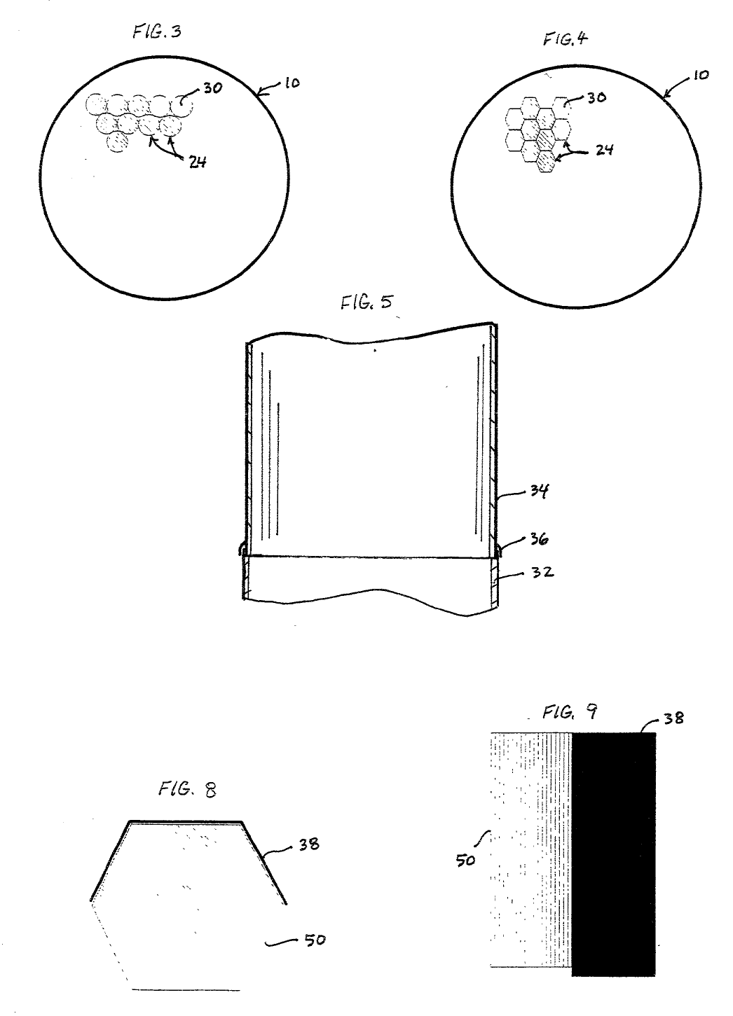

The external walls 26 of the smaller column 24 can have any desired cross-sectional configuration, such as the circular shape illustrated in FIG. 3 or a polygonal shape such as the hexagonal shape illustrated in FIG. 4. Square, triangular and hexagonal shapes are generally preferred because they allow the smaller columns 24 to nest against each other without forming small voids between the smaller columns as in the case with the circular shape. The longitudinal length of the external wall 26 of some or all of the smaller columns 24 can be of a single piece construction or can be formed be two or more wall segments 32 and 34 placed end to end and joined together in any of various fashions, such as by inserting the lower end of the upper wall segment 34 within the upper end of the adjacent lower wall segment 32 as illustrated in FIG. 5. Tabs 36 formed in the end of one or both wall segments 32 and 34 may be used to limit the depth to which the end of wall segment 34 can be inserted within wall segment 32. The external wall 26 may also be formed from two or more wall panels, such as panels 38, 39 and 40 which are joined or simply abutted together along their sides as illustrated in FIG. 6. Constructing the external wall 26 in this manner allows adjacent smaller columns 24 to share a common wall along a portion or all of their perimeters. If desired, a double wall can also be formed along a portion or all of the perimeters of the smaller columns 24.

As shown in FIG. 1, liquid is individually fed into the open upper ends of the smaller columns 24 by a liquid distributor 44 so that equal amounts of liquid can be fed to each smaller column 24. The bottoms of the smaller columns 24 are open and are preferably supported on a grid 46 that is itself supported by a support ring 48 that is secured to an inner surface of the larger column shell 12.

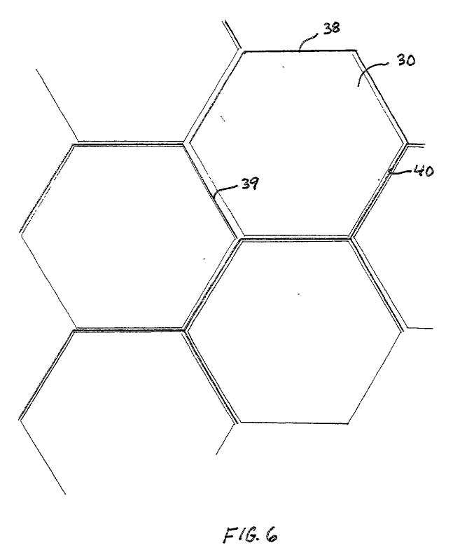

The packing 30 may be random packing, but is preferably structured packing such as corrugated, parallel sheets or plates 48. As can be seen in FIG. 2, the plates 48 are vertically disposed and the corrugations extend at an angle to the vertical axis of the smaller columns 24. The plates 48 are arranged so that the corrugations of adjacent plates extend in crisscrossing relationship and are in contact with each other. Turning to FIG. 7, the plates 48 can be held together in a brick 50 using pins, bolts, rivets, welding, soldering or preferably mesh banding 52 as is well-known in the art. The mesh banding 52 is slit and bent outwardly along its top or bottom to form wall wipe bands 54 that redirect liquid descending along the inner surface of the external walls 26 back into the packing 30. The packing 30 can be installed within the smaller columns 24 after the external walls 26 of the smaller columns 24 have been assembled within the larger column 10. Alternatively, the packing 30 can be installed as the external walls 26 are being assembled. For example, packing 30 can be installed in lower wall segments 32 before the upper wall segments 34 are installed. After some or all of the lower wall segments 32 have been filled with packing 30, the upper wall segments 34 can be installed and then similarly filled with packing 30. Likewise, when wall panels 38 and 40 or 42 are used, the packing 30 can be inserted as some or all of the perimeter of the smaller columns 24 is formed. In a still further embodiment, the packing 30 may be preassembled with portions of the external walls 26 outside of the larger column 10. For example, as shown in FIGS. 8 and 9, one or more packing bricks 50 may be preassembled with one wall panel 38 or 40 before the wall panels 38 and 40 are assembled within the larger column 10 to form the external walls 26 of the smaller columns 24.

The packing 30 preferably fills the smaller columns 24 from top to bottom and may be arranged in a plurality of horizontal layers, each of which is in contact with and rotated 90° or other desired angle from a vertically adjacent layer. The total height of the packing 30 within the smaller columns 24 can be selected to suit particular process conditions.

Without wishing to be bound by any particular theory, the improved separation efficiencies believed to be obtainable with the packing 30 in the smaller columns 24 results from: (1) eliminating the gaps that are formed between the sides and ends of adjacent packing bricks in commercial-sized columns packing is made in bricks which may cause gaps to be formed at the ends and/or sides of the bricks; (2) using wall wiper bands around each packing element to redirect liquid from the small column walls back into the packing; and (3) facilitating lateral liquid mixing because the liquid flow channels along the inclined corrugations do not extend from the top to the bottom of the element without first hitting the column wall.

It is believed that liquid and/or vapor maldistribution does not occur or is substantially reduced in smaller columns 24. Alternatively, if maldistribution should occur, for instance at the top of the smaller columns 24 due to a flooded column 10, correction takes place within a short distance and separation efficiency recovers. The smaller column diameter also reduces or prevents channeling of liquid and distortion of the liquid/vapor ratios across the cross section of the column which causes the net effective separation to be negatively affected.

From the foregoing, it will be seen that this invention is one well adapted to attain all the ends and objectives hereinabove set forth together with other advantages which are inherent to the structure.

It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative and not in a limiting sense.

Having thus described the invention, what is claimed is:

1. A mass transfer column comprising:
an external shell defining an open internal region;
a plurality of vertically extending smaller columns supported within said open internal region, said smaller columns having external walls which define internal fluid passages having a horizontal cross section, the external walls of at least some of said smaller columns being in contact with the external walls of adjacent smaller columns within said open internal region; and
vapor-liquid contact packing within said internal fluid passages of at least some of the smaller columns.

2. The mass transfer column as in claim 1, wherein said vapor-liquid contact packing comprises structured packing.

3. The mass transfer column as in claim 2, wherein said structured packing comprises a plurality of vertically extending parallel plates having corrugations which extend at an angle to vertical.

4. The mass transfer column as in claim 3, wherein the corrugations of adjacent plates are in contact with and extend at an angle to each other.

5. The mass transfer column as in claim 2, wherein said structured packing fills the cross section of said internal fluid passages.

6. The mass transfer column as in claim 2, wherein at least some of said external walls comprise vertically aligned wall segments which are joined together.

7.The mass transfer column as in claim 2, wherein a portion of the external wall of at least one of said small columns forms a portion of the external wall of an adjacent one of said small columns.

8. The mass transfer column as in claim 7, wherein said external walls are formed by two or more wall panels placed side by side.

9. The mass transfer column as in claim 8, wherein at least some of said structured packing is joined to one or more of said wall panels.

10. The mass transfer column as in claim 8, wherein said wall panels are fluid impermeable.

11. The mass transfer column of claim 1, including a grid extending across said open internal region and wherein said smaller columns are positioned on and supported by said grid.

12. The mass transfer column as in claim 1, wherein said smaller columns are cylindrical in configuration.

13. The mass transfer column as in claim 1, wherein said smaller columns have a polygonal cross section.

14. A method of constructing a plurality of longitudinally extending smaller mass transfer columns within a larger column, said method comprising the steps of:
assembling together a plurality of wall panels within said larger diameter column to form external walls of a plurality of parallel extending smaller columns having internal fluid passages, at least some of said panels forming a common portion of the external walls of adjacent smaller columns; and
packing within said internal fluid passages of the smaller columns.

15. The method of claim 14, wherein said step of installing packing comprising installing structured packing as said external walls of the smaller columns are being formed.

16. The method of claim 14, wherein said step of installing packing comprising installing structured packing after said external walls of the smaller columns have been formed.

17. The method of claim 14, wherein said step of assembling together a plurality of wall panels comprises joining together wall segments in end to end relationship.
